(19) United States
(12) Patent Application Publication
(10) Pub. No.: US 2010/0165220 A1
(43) Pub. Date: Jul. 1, 2010

(54) LIQUID CRYSTAL DISPLAY DEVICE AND PROJECTOR

(75) Inventors: Takashi ENDO, Azumino-shi (JP); Yoshitake TATENO, Suwa-gun (JP); Takuro NAGATSU, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/644,986

(22) Filed: Dec. 22, 2009

(30) Foreign Application Priority Data
Dec. 26, 2008 (JP) 2008-332977

(51) Int. Cl. G02F 1/1335; G02F 1/13363; G02F 1/1333

(52) U.S. Cl. 349/8; 349/117; 349/122

(57) ABSTRACT

A liquid crystal display device includes: a liquid crystal panel having a liquid crystal device and a dust-proof plate disposed on at least one of a light entrance side and a light exit side of the liquid crystal device; and a first polarization filter disposed so as to be opposed to the liquid crystal panel across the dust-proof plate, wherein a direction of an absorption axis of the first polarization filter and a direction of an optical axis of the dust-proof plate are perpendicular to each other, and the dust-proof plate is made of a positive uniaxial crystalline material, and satisfies a following relational expression denoting a refractive index difference with respect to two directions perpendicular to a system optical axis as Δn, a thickness in a system optical axis direction as d, and a wavelength to be used as λ, and using an integer N:

N≦Δnd/λ≦N+1/2.

### BACKGROUND

1. Technical Field

The present invention relates to a liquid crystal display device for forming an image, and a projector incorporating the liquid crystal display device.

2. Related Art

As a liquid crystal display device to be incorporated in a projector or the like, there exists a device mainly composed of a liquid crystal panel, an entrance polarization plate, and an exit polarization plate. It is disclosed that in such a liquid crystal display device, for example, a dust-proof glass member disposed on the light entrance side and a dust-proof glass member disposed on the light exit side are arranged to be formed of quartz plates, and the optical axes of the quartz plates are set in a direction perpendicular to the entrance surface (see JP-A-2006-350291). It is also disclosed that the dust-proof glass disposed on the light entrance side and the dust-proof glass disposed on the light exit side are similarly arranged to be formed of the quartz plates, and the optical axes (c axes) of the quartz plates are arranged to follow the direction of the air flow caused by a blower fan (see JP-A-2004-117580).

However, as a result of the study by the inventors, it has turned up that in the case of replacing the dust-proof glass member with a crystal material such as a quartz plate, the contrast of the display image might be degraded unless the positional relationship with the polarization plate opposed thereto is considered.

### SUMMARY

An advantage of some aspects of the invention is to provide a liquid crystal display device capable of preventing the degradation of the contrast of the display image even in the case of replacing the dust-proof glass member with the crystal material such as a quartz plate.

Another advantage of some aspects of the invention is to provide a projector incorporating the liquid crystal display device described above.

According to a first aspect of the invention, there is provided a liquid crystal display device including a liquid crystal panel having a liquid crystal device and a dust-proof plate disposed on at least one of a light entrance side and a light exit side of the liquid crystal device, and a first polarization filter disposed so as to be opposed to the liquid crystal panel across the dust-proof plate. Here, a direction of an absorption axis of the first polarization filter and a direction of an optical axis of the dust-proof plate are perpendicular to each other, and the dust-proof plate is made of a positive uniaxial crystalline material, and satisfies a following relational expression denoting a refractive index difference with respect to two directions perpendicular to a system optical axis as Δn, a thickness in a system optical axis direction as d, and a wavelength to be used as λ, and using an integer N.

N≦Δnd/λ≦N+1/2 (1)

In the liquid crystal display device described above, since the direction of the absorption axis of the polarization filter and the direction of the optical axis of the dust-proof plate made of a positive uniaxial crystalline material are perpendicular to each other, the light beam entering in a state parallel to the system optical axis is not affected by the birefringent action in the dust-proof plate when passing through the polarization filter. Therefore, it is possible to prevent the phenomenon that the modulated light with the modulation amount varied due to the refractive index anisotropy of the dust-proof plate is emitted while enhancing the cooling efficiency by the dust-proof plate made of the positive uniaxial crystalline material. Further, in the liquid crystal display device described above, it is conceivable that even if the light beam entering in a state tilted from the system optical axis is affected by the birefringent action of the dust-proof plate when passing through the dust-proof plate, such birefringent action is canceled out with the birefringent action caused in the liquid crystal panel. Therefore, since the modulated light having the field angle compensation effect of the liquid crystal panel with respect to the light beam tilted from the system optical axis can be obtained, the liquid crystal display device having a preferable field angle characteristic with respect to the contrast ratio can be provided.

According to a second aspect of the invention, there is provided a liquid crystal display device including a liquid crystal panel having a liquid crystal device and a dust-proof plate disposed on at least one of a light entrance side and a light exit side of the liquid crystal device, and a first polarization filter disposed so as to be opposed to the liquid crystal panel across the dust-proof plate. Here, a direction of an absorption axis of the first polarization filter and a direction of an optical axis of the dust-proof plate are perpendicular to each other, and the dust-proof plate is made of a negative uniaxial crystalline material, and satisfies a following relational expression denoting a refractive index difference with respect to two directions perpendicular to a system optical axis as Δn, a thickness in a system optical axis direction as d, and a wavelength to be used as λ, and using an integer N.

N−1/2≦Δnd/λ≦N (2)

In the liquid crystal display device described above, since the direction of the absorption axis of the polarization filter and the direction of the optical axis of the dust-proof plate made of a negative uniaxial crystalline material are perpendicular to each other, the light beam entering in a state parallel to the system optical axis is not affected by the birefringent action in the dust-proof plate when passing through the polarization filter. Therefore, it is possible to prevent the phenomenon that the modulated light with the modulation amount varied due to the refractive index anisotropy of the dust-proof plate is emitted while enhancing the cooling efficiency by the dust-proof plate made of the negative uniaxial crystalline material. Further, in the liquid crystal display device described above, it is conceivable that even if the light beam entering in a state tilted from the system optical axis is affected by the birefringent action of the dust-proof plate when passing through the dust-proof plate, such birefringent action is canceled out with the birefringent action caused in the liquid crystal panel. Therefore, since the modulated light having the field angle compensation effect of the liquid crystal panel with respect to the light beam tilted from the system optical axis can be obtained, the liquid crystal display device having a preferable field angle characteristic with respect to the contrast ratio can be provided.

Further, according to a specific aspect of the invention, in the liquid crystal display device described above, the dust-proof plate is made of either one of quartz crystal and sapphire. In this case, it is possible to reliably cool the liquid crystal device while preventing the loss of the light intensity due to the dust-proof plate.

Further, according to another aspect of the invention, the liquid crystal device has a pair of substrates adapted to hold a liquid crystal layer on both sides of the liquid crystal layer, and a displaying electrode formed on one of the pair of substrates.

Further, according to still another aspect of the invention, there is further provided a second polarization filter disposed across the liquid crystal panel from the first polarization filter. In this case, the liquid crystal panel is a transmissive light modulation device, and the polarization filter on the light entrance side adjusts the polarization direction of the illumination light entering the liquid crystal panel, and at the same time, the polarization filter on the light exit side takes out the modulated light with a predetermined polarization direction from the light emitted from the liquid crystal panel.

In view of the problems described above, a projector according to another aspect of the invention includes an illumination device adapted to emit a light beam for illumination, a color separation optical system adapted to separate a plurality of colored light beams from the light beam emitted from the illumination device, and lead the plurality of colored light beams to optical paths of respective colors corresponding to the colored light beams, a light modulation section having the liquid crystal display device disposed on each of the optical paths of the respective colors, and adapted to modulate corresponding one of the plurality of colored light beams in accordance with image information, a light combining optical system adapted to combine the modulated light beams of the respective colors from the liquid crystal display devices of the respective colors disposed on the optical paths of the respective colors, and emit the combined light beam, and a projection optical system adapted to project the combined light beam formed by combining the modulated light beams through the light combining optical system.

The projector described above is provided with the light modulation section having the liquid crystal display device according to the aspects of the invention described above, and since the field angle characteristic with respect to the contrast ratio can be made preferable while preventing the temperature rise in the liquid crystal display device, a high quality image can be projected.

Further, according to a specific aspect of the invention, in the projector described above, the illumination device emits the illumination light beam with a polarization direction aligned in a predetermined direction, the liquid crystal display devices of the respective colors modulate the colored light beams with a common polarization direction, and the light combining optical system has at least one dichroic mirror tilted around an axis passing through a system optical axis and perpendicular to the system optical axis, and combines image light beams of the respective colors using a wavelength characteristic of the at least one dichroic mirror. Further, the light modulation section has a first type liquid crystal display device adapted to emit a modulated light beam to be reflected by the at least one dichroic mirror, and a second type liquid crystal display device adapted to emit a modulated light beam to be transmitted through the at least one dichroic mirror as the liquid crystal display devices of the respective colors, and has a phase plate adapted to switch the polarization direction 90° disposed between either one of the first type liquid crystal display device and the second type liquid crystal display device, and the light combining optical system. In this case, by aligning the polarization direction of the light beams to be input to the liquid crystal display devices of the respective colors, it is possible to achieve standardization of the characteristics of the polarization filters, the dust-proof plates, and so on in all of the optical paths, and at the same time, it is possible to make the combining process of the modulated light beams using the dichroic mirror efficient using the phase plate selectively disposed on the optical path of a specific color.

### BRIEF DESCRIPTION OF THE DRAWINGS

The invention will be described with reference to the accompanying drawings, wherein like numbers reference like elements.

FIG. 1 is a diagram for explaining an optical system of a projector incorporating a liquid crystal display device according to a first embodiment of the invention.

FIG. 2 is an enlarged cross-sectional view of a B light liquid crystal light valve constituting the projector shown in FIG. 1.

FIGS. 3A through 3C are explanatory diagrams for explaining a function of a dust-proof plate incorporated in the liquid crystal light valve.

FIG. 4 is an enlarged cross-sectional view of a G light liquid crystal light valve constituting the projector shown in FIG. 1.

FIG. 5A is a diagram for explaining a field angle characteristic of a contrast ratio of the liquid crystal light valve according to the present embodiment, and FIG. 5B is a diagram for explaining a field angle characteristic of a contrast ratio of a liquid crystal light valve according to a comparative example.

FIG. 6 is a graph for explaining a variation in the contrast ratio in the case of varying the thickness of an entrance side dust-proof plate.

FIG. 7 is an enlarged cross-sectional view of a B light liquid crystal light valve according to a second embodiment.

FIG. 8A is a diagram for explaining a field angle characteristic of a contrast ratio of the liquid crystal light valve according to the present embodiment, and FIG. 8B is a diagram for explaining a field angle characteristic of a contrast ratio of a liquid crystal light valve according to a comparative example.

FIG. 9 is an enlarged cross-sectional view of a B light liquid crystal light valve according to a third embodiment.

FIG. 10 is a graph for explaining a variation in the contrast ratio in the case of varying the thickness of an entrance side dust-proof plate.

FIG. 11 is an enlarged cross-sectional view of a G light liquid crystal light valve according to the third embodiment.

FIG. 12 is an enlarged cross-sectional view of a B light liquid crystal light valve according to a fourth embodiment.

FIG. 13 is a graph for explaining a relationship between the thickness of the entrance side dust-proof plate and the contrast ratio in a fifth embodiment.

### DESCRIPTION OF EXEMPLARY EMBODIMENTS

### First Embodiment

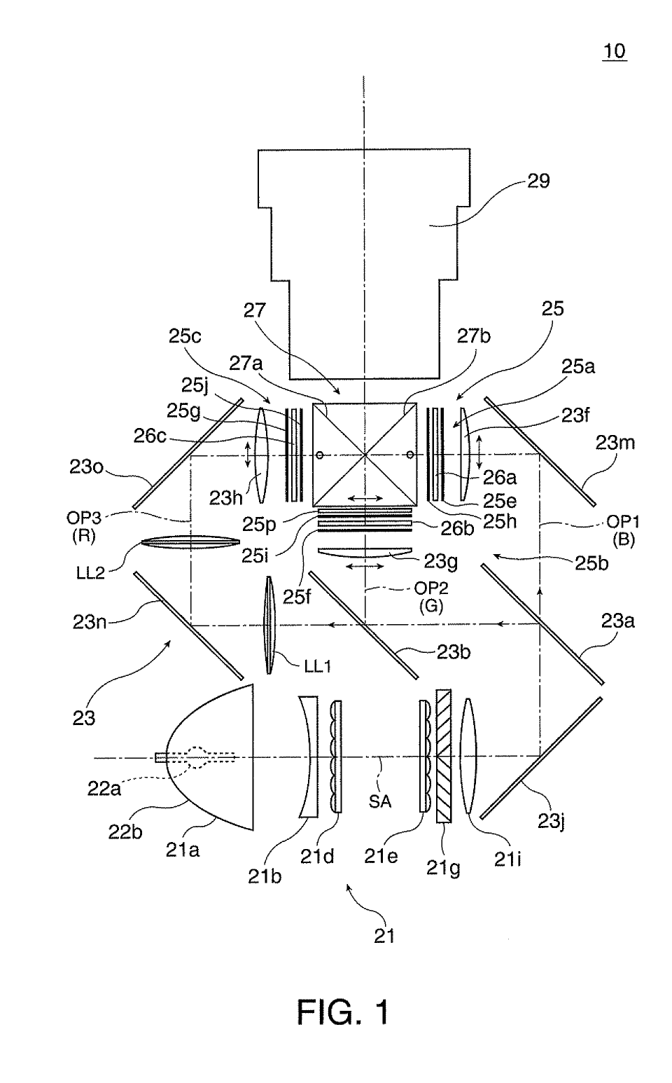

FIG. 1 is a conceptual diagram for explaining a configuration of an optical system of a projector incorporating a liquid crystal display device according to a first embodiment of the invention.

The present projector 10 is provided with a light source device 21 for generating source light, a color separation optical system 23 for separating the source light from the light source device 21 into three light beams of respective colors of blue, green, and red, a light modulation section 25 illuminated by the illumination light beams of the respective colors emitted from the color separation optical system 23, a cross dichroic prism 27 for combining image light beams of the respective colors emitted from the light modulation section 25, and a projection lens 29 for projecting the image light beams passing through the cross dichroic prism 27 on a screen (not shown).

In the projector 10 described above, the light source device 21 is provided with a light source lamp 21a, a concave lens 21b, a pair of lens arrays 21d, 21e, a polarization conversion member 21g, and an overlapping lens 21i. Among these components, the light source lamp 21a is provided with a lamp main body 22a such as a high-pressure mercury lamp, and a concave mirror 22b for collecting the source light and emitting it forward. The concave lens 21b, which has a role of collimating the source light from the light source lamp 21a, can also be eliminated in the case in which, for example, the concave mirror 22b is a paraboloidal mirror. Each of the pair of lens arrays 21d, 21e is composed of a plurality of element lenses arranged in a matrix, and divides the source light from the light source lamp 21a passing through the concave lens 21b with these element lenses to be individually collected or diffused. The polarization conversion member 21g is provided with a prism array incorporating a PBS and a mirror, and a phase plate array attached on an exit surface, which is provided to the prism array, in a striped manner, although detailed explanations thereof will be omitted. The polarization conversion member 21g converts the source light emitted from the lens array 21e only into linearly polarized light with a first polarization direction horizontal (in further specifically, perpendicular to an intersection line between a first dichroic mirror 27a and a second dichroic mirror 27b of the cross dichroic prism 27 described later) with respect to the sheet of FIG. 1, for example, and then supplies the posterior optical system with the linear polarized light. The overlapping lens 21i appropriately collects the illumination light passing through the polarization conversion member 21g as a whole, thereby making it possible to illuminate the liquid crystal light valves 15a, 25b, and 25c of the respective colors provided to the light modulation section 25 in an overlapping manner. Specifically, the illumination light passing through both the lens arrays 21d, 21e and the overlapping lens 21i evenly illuminates the liquid crystal panels 26a, 26b, and 26c of the respective colors disposed in the light modulation section 25 in an overlapping manner after passing through the color separation optical system 23 described below in detail.

The color separation optical system 23 is provided with first and second dichroic mirrors 23a, 23b, field lenses 23f, 23g, and 23h, and reflecting mirrors 23j, 23m, 23n, and 23o, and constitutes the illumination device together with the light source device 21. Here, the first dichroic mirror 23a transmits, for example, the blue (B) light out of the light of three colors of blue, green, and red, and reflects the green (G) light and the red (R) light. Further, the second dichroic mirror 23b reflects, for example, the green (G) light out of the incident light of the two colors of green and red, and transmits the red (R) light. Thus, the B light, the G light, and the R light constituting the source light are led respectively to first, second, and third optical paths OP1, OP2, and OP3, and respectively enter different illumination objects. In a specific explanation, the source light from the light source device 21 enters the first dichroic mirror 23a with the optical path folded by the reflecting mirror 23j. The B light transmitted through the first dichroic mirror 23a enters the field lens 23f opposed to the liquid crystal light valve 25a via the reflecting mirror 23m. Further, the G light reflected by the first dichroic mirror 23a, and further reflected by the second dichroic mirror 23b enters the field lens 23g opposed to the liquid crystal light valve 25b. Further, the R light transmitted through the second dichroic mirror 23b enters the field lens 23h opposed to the liquid crystal light valve 25c via the lenses LL1, LL2, and the reflecting mirrors 23n, 23o. It should be noted that the field lenses 23f, 23g, and 23h have a function of controlling the incident angles of the illumination light entering the liquid crystal light valves 25a, 25b, and 25c, respectively. The lenses LL1, LL2 and the field lens 23h constitute a relay optical system. The relay optical system has a function of transmitting the image in the first lens LL1 to the field lens 23h via the second lens LL2 without any substantial modification.

The light modulation section 25 is provided with the three liquid crystal light valves 25a, 25b, and 25c in accordance with the three optical paths OP1, OP2, and OP3 for the respective colors described above. Each of the liquid crystal light valves 25a, 25b, and 25c is a passive light modulation device for modulating the spatial distribution of the intensity of the incident illumination light.

Here, the B light liquid crystal light valve 25a disposed on the first optical path OP1 is an embodiment of the liquid crystal display device, and is provided with a liquid crystal panel 26a illuminated by the B light, a polarization filter 25e disposed on an entrance side of the liquid crystal panel 26a, and a polarization filter 25h disposed on an exit side of the liquid crystal panel 26a. The liquid crystal light valve 25a is disposed on a subsequent stage of the field lens 23f provided to the color separation optical system 23, and is uniformly illuminated by the B light transmitted through the first dichroic mirror 23a. In the liquid crystal light valve 25a, the polarization filter 25e selectively transmits the linear polarized light with a first polarization direction parallel to the sheet with respect to the B light thus input, and then leads the linear polarized light to the liquid crystal panel 26a. Here, the first polarization direction denotes the direction (an X axis direction described later) perpendicular to the intersection line between the first dichroic mirror 27a and the second dichroic mirror 27b of the cross dichroic prism 27, as described above. The liquid crystal panel 26a converts the linear polarized light with the first polarization direction input thereto into, for example, linear polarized light with a second polarization direction perpendicular to the sheet partially in accordance with the image signal. Here, the second polarization direction denotes the direction (a Y axis direction described later) parallel to the intersection line between the first dichroic mirror 27a and the second dichroic mirror 27b of the cross dichroic prism 27. The polarization filter 25h selectively transmits only the linear polarized light with the second polarization direction obtained by the modulation through the liquid crystal panel 26a.

The G light liquid crystal light valve 25b disposed on the second optical path OP2 is an embodiment of the liquid crystal display device, and is provided with a liquid crystal panel 26b illuminated by the G light, a polarization filter 25f disposed on an entrance side of the liquid crystal panel 26b, a polarization filter 25i disposed on an exit side of the liquid crystal panel 26b, and a 1/2 λ plate 25p as a phase plate. The liquid crystal light valve 25b is disposed on a subsequent stage of the field lens 23g provided to the color separation optical system 23, and is uniformly illuminated by the G light reflected by the second dichroic mirror 23b. In the liquid crystal light valve 25b, the polarization filter 25f selectively transmits the linear polarized light with the first polarization direction parallel to the sheet with respect to the G light thus input, and then leads the linear polarized light to the liquid crystal panel 26b. The liquid crystal panel 26b converts the linear polarized light with the first polarization direction input thereto into, for example, linear polarized light with the second polarization direction perpendicular to the sheet partially in accordance with the image signal. The polarization filter 25i selectively transmits only the linear polarized light with the second polarization direction obtained by the modulation through the liquid crystal panel 26b. The 1/2 λ plate 25p rotates the polarization direction of the linear polarized light with the second polarization direction thus transmitted through the polarization filter 25i 90°, thereby switching the linear polarized light with the second polarization direction to the linear polarized light with the first polarization direction parallel to the sheet.

The R light liquid crystal light valve 25c disposed on the third optical path OP3 is an embodiment of the liquid crystal display device, and is provided with a liquid crystal panel 26c illuminated by the R light, a polarization filter 25g disposed on an entrance side of the liquid crystal panel 26c, and a polarization filter 25j disposed on an exit side of the liquid crystal panel 26c. The liquid crystal light valve 25c is disposed on a subsequent stage of the field lens 23h provided to the color separation optical system 23, and is uniformly illuminated by the R light transmitted through the second dichroic mirror 23b. In the liquid crystal light valve 25c, the polarization filter 25g selectively transmits the linear polarized light with the first polarization direction parallel to the sheet with respect to the R light thus input, and then leads the linear polarized light to the liquid crystal panel 26c. The liquid crystal panel 26c converts the linear polarized light with the first polarization direction input thereto into, for example, linear polarized light with the second polarization direction perpendicular to the sheet partially in accordance with the image signal. The polarization filter 25j selectively transmits only the linear polarized light with the second polarization direction obtained by the modulation through the liquid crystal panel 26c.

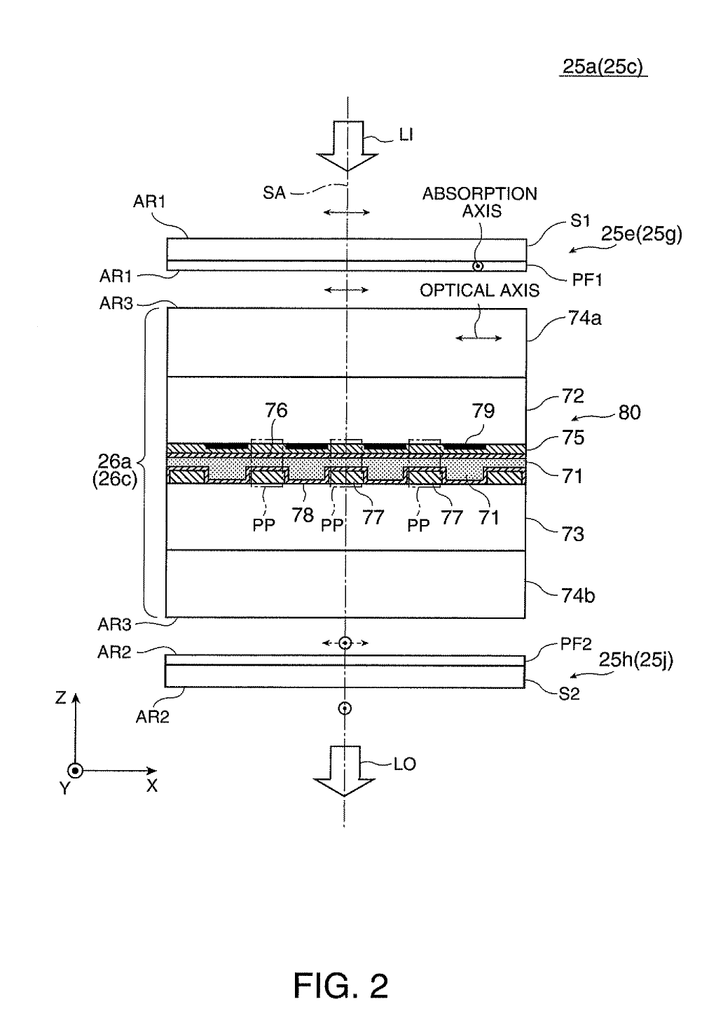

FIG. 2 is an enlarged cross-sectional diagram for explaining a structure of the B light liquid crystal light valve 25a constituting the light modulation section of the projector 10 shown in FIG. 1. It should be noted that in FIG. 2, the Z axis direction corresponds to a direction along which a system optical axis SA extends. Further, it is assumed that the X axis direction corresponds to the direction perpendicular to the intersection line between the first and second dichroic mirrors 27a, 27b in the cross dichroic prism 27, and the Y axis direction corresponds to the direction parallel to the intersection line between the first and second dichroic mirrors 27a, 27b.

In the liquid crystal light valve 25a, the polarization filter 25e disposed on the entrance side is formed by bonding a first polarization film PF1 made of resin on a substrate S1, and is arranged to have the entrance surface and the exit surface with normal lines parallel to the system optical axis SA, namely the Z axis. The polarization filter 25e transmits only the P polarized light with the first polarization direction along the X axis direction using the first polarization film PF1 as a polarization element. In other words, an absorption axis of the polarization filter 25e extends in the Y axis direction. Here, the substrate S1 for supporting the first polarization film PF1 is made, for example, of quartz glass, and emits the P polarized light with the first polarization direction, which is along the X axis direction, along the system optical axis SA without any modification. It should be noted that the entrance surface and the exit surface of the polarization filter 25e are each provided with an antireflection film AR1, thereby preventing stray light from occurring.

On the other hand, the polarization filter 25h disposed on the exit side is formed by bonding a second polarization film PF2 made of resin on a substrate S2, and is arranged to have the entrance surface and the exit surface with normal lines parallel to the system optical axis SA, namely the Z axis. The polarization filter 25h transmits only the S polarized light with the second polarization direction along the Y axis direction using the second polarization film PF2 as a polarization element, and eliminates the P polarized light (unmodulated light) by, for example, absorption. In other words, the absorption axis of the polarization filter 25h extends in the X axis direction. Here, the substrate S2 for supporting the second polarization film PF2 is made, for example, of quartz glass, and emits the S polarized light with the second polarization direction, which is along the Y axis direction, along the system optical axis SA without any modification. It should be noted that the entrance surface and the exit surface of the polarization filter 25h are each provided with an antireflection film AR2, thereby preventing stray light from occurring.

Although it is assumed in the case described above that the substrate S2 for supporting the second polarization film PF2 is made of quartz glass, by adopting the substrate S2 made of quarts crystal, it is possible to efficiently cool the second polarization film PF2 in the condition of being heated with relative ease compared to the first polarization film PF1.

As is obvious from the above explanations, the first polarization film PF1 forming the polarization filter 25e and the second polarization film PF2 forming the polarization filter 25h are arranged so as to form a cross-Nicol arrangement. The liquid crystal panel 26a located between the first and second polarization films PF1, PF2 modulates the incident light LI having entered from the first polarization film PF1 side partially from the P polarized light to the S polarized light pixel by pixel in accordance with an input signal, and then emits the modulated light thus modulated to the second polarization film PF2 side as outgoing light LO. As described above, the modulated light emitted from the liquid crystal light valve 25a is formed as the outgoing light LO in the S polarization state suitable for the light combination in the cross dichroic prism 27 described later.

The liquid crystal panel 26a between both the polarization filters 25e, 25h is provided with a first substrate 72 disposed on the entrance side and a second substrate 73 disposed on the exit side across a liquid crystal layer 71 formed of liquid crystal (i.e., vertically-aligned liquid crystal) operating in a vertically-aligned mode. Each of these substrates 72, 73 has a planar shape, and is arranged to have the entrance surface and the exit surface with normal lines parallel to the system optical axis SA, namely the Z axis, similarly to the case of the polarization filter 25e and so on. On the outer side of the first substrate 72, there is attached a light transmissive entrance-side dust-proof plate 74a, and on the outer side of the second substrate 73, there is attached a light transmissive exit-side dust-proof plate 74b. Each of these dust-proof plates 74a, 74b has a planar shape, and is arranged to have the entrance surface and the exit surface with normal lines parallel to the system optical axis SA, namely the Z axis, similarly to the case of the polarization filter 25e and so on. An entrance surface on the entrance-side dust-proof plate 74a side and an exit surface on the exit-side dust-proof plate 74b side of the liquid crystal panel 26a are each provided with an antireflection film AR3, thereby preventing stray light from occurring.

The entrance-side dust-proof plate 74a is a flat plate made of a positive uniaxial crystalline material, specifically quartz crystal, and the exit-side dust-proof plate 74b is a flat plate made of an isotropic inorganic material, specifically quartz glass. The entrance-side dust-proof plate 74a is hewed out so that the optical axis of the quartz crystal forming the plate extends in the X axis direction. In other words, the optical axis of the entrance-side dust-proof plate 74a is arranged to have a state perpendicular to the absorption axis of the polarization filter 25e.

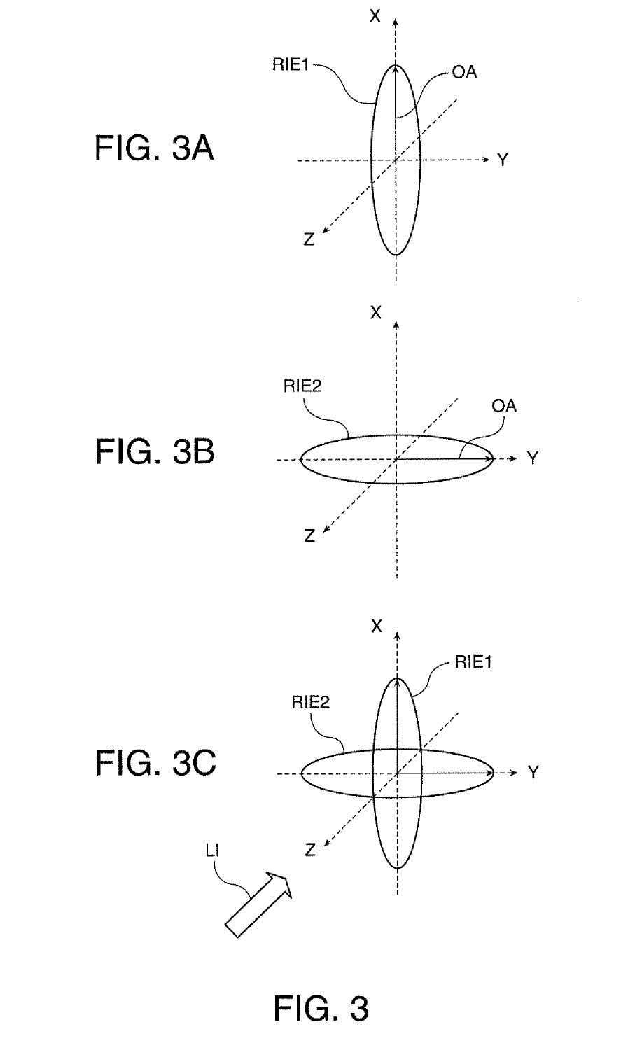

FIGS. 3A through 3C are diagrams for explaining a function of the entrance-side dust-proof plate 74a. As shown in FIG. 3A, the quartz crystal forming the entrance-side dust-proof plate 74a has optical anisotropic nature corresponding to positive uniaxial refractive index ellipsoid RIE1 having relatively large refractive index with respect to the direction of the optical axis OA extending in the X axis direction. When explaining it using a specific magnitude correlation, assuming the refractive indexes with respect to the respective directions of X, Y, and Z in the drawing as NX, NY, and NZ, the relation of NY=NZ<NX is obtained. On the other hand, the first polarization film PF1 of the polarization filter 25e is a stretched film formed by attaching a polyvinyl alcohol (PVA) material, which is stained with, for example, dye absorbed thereto, on a triacetylcellulose (TAC) material, and is provided with an absorption coefficient in the stretching direction thereof. The fact that the first polarization film PF1 has the absorption coefficient denotes that although the refractive index includes the imaginary part (NX=NZ=n, NY=n+in′, where n and n′ are refractive indexes, and the ideal case in which 100% of the light is transmitted in the transmission axis direction is assumed), the first polarization film PF1 can be treated as a refractive index ellipsoid similarly to the entrance-side dust-proof plate 74a, and therefore, the first polarization film PF1, namely the polarization filter 25e acts in a similar manner to the positive uniaxial refractive index ellipsoid RIE2 as shown in FIG. 3B. Therefore, assuming the incident light LI entering the liquid crystal light valve 25a, if the incident light LI is parallel to the system optical axis SA, namely the Z axis, then the optical axes extending along the X axis direction or the Y axis direction are apparently maintained even in the case in which the polarization filter 25e and the entrance-side dust-proof plate 74a are combined with each other, as shown in FIG. 3C. In other words, it does not happen that the entrance-side dust-proof plate 74a performs action on the phase state of the incident light LI to modulate the polarization direction, and it does not happen that the polarization filter 25e modulates the polarization direction for the same reason. However, the incident light LI entering the liquid crystal light valve 25a includes a component entering at a tilt with the system optical axis SA, namely the Z axis, and with respect to such an obliquely incident component, the optical axis OA of the refractive index ellipsoid RIE2 of the polarization filter 25e and the optical axis OA of the refractive index ellipsoid RIE1 of the entrance-side dust-proof plate 74a are no longer maintained to form an apparent angle of 90°. Therefore, with respect to the obliquely incident component, the entrance-side dust-proof plate 74a and the polarization filter 25e perform action on the phase state of the incident light LI to modulate the polarization direction. Here, since the obliquely incident component of the incident light LI affects the field angle characteristic of the contrast, it is desirable that the phase action by the entrance-side dust-proof plate 74a and the polarization filter 25e compensates the field angle characteristic of the liquid crystal light valve 25a. Therefore, in the present embodiment, it is arranged that the following relational expression is satisfied denoting a refractive index difference with respect to two directions perpendicular to the system optical axis SA of the entrance-side dust-proof plate 74a as Δn (=|NX−NY|), the thickness thereof in the system optical axis SA direction as d, and the wavelength of the B light used therein as λ.

N≦Δnd/λ≦N+1/2 (1)

(where N is an integer)

In other words, it has been experimentally confirmed that the phenomenon that the modulated light with the modulation amount varied by the refractive index anisotropy of the entrance-side dust-proof plate 74a is emitted from the liquid crystal light valve 25a can be prevented by arranging that the phase shift of the entrance-side dust-proof plate 74a in the optical axis OA direction becomes equal to or smaller than a half wavelength, although the details thereof will be described later.

Going back to FIG. 2, in the liquid crystal panel 26a, on the surface of the first substrate 72 facing the liquid crystal layer 71, there is provided a transparent common electrode 75, on which an oriented film 76, for example, is formed. Meanwhile, on the surface of the second substrate 73 facing the liquid crystal layer 71, there are provided a plurality of transparent pixel electrode 77 as displaying electrodes arranged in a matrix, wiring (not shown) electrically connectable to each of the transparent pixel electrodes 77, and thin film transistors (not shown) intervening between the transparent pixel electrodes 77 and the wiring, on which an oriented film 78, for example, is formed. Here, the first and second substrates 72, 73, the liquid crystal layer 71 held between these substrates, and the electrodes 75, 77 correspond to a part functioning as an optically active element, namely a liquid crystal device 80 for modulating the polarization state of the incident light LI in accordance with the input signal. Each of pixel portions PP constituting the liquid crystal device 80 includes one transparent pixel electrode 77, a part of the common electrode 75, a part of each of the oriented films 76, 78, and a part of the liquid crystal layer 71. It should be noted that between the first substrate 72 and the common electrode 75, there is disposed a lattice-shaped black matrix 79 so as to partition each of the pixel portions PP.

In the liquid crystal device 80 described hereinabove, the oriented films 76, 78 have a role of arranging the liquid crystalline compound forming the liquid crystal layer 71 in the condition substantially parallel to the system optical axis SA, namely the Z axis, in the condition in which no electrical field exists. It should be noted that in the case in which an appropriate electrical field in the direction along the Z axis is formed, the liquid crystalline compound forming the liquid crystal layer 71 is tilted from the state of substantially parallel to the system optical axis SA, namely the Z axis toward, for example, a predetermined direction in the XY plane. Thus, the liquid crystal layer 71 held between the pair of polarization films PF1, PF2 is operated in a normally black mode, and it becomes possible to assure the maximum light-blocking state (extinction state) in an off state in which no voltage is applied. In other words, the liquid crystal panel 26a transmits the P polarized light without any modification when performing black display in the extinction state. Further, the liquid crystal panel 26a transmits the P polarized light while switching the P polarized light to the S polarized light when performing white display in a lighting state.

Although the structure and the function of the B light liquid crystal light valve 25a are explained hereinabove with reference to FIG. 2 and so on, the R light liquid crystal light valve 25c also has substantially the same structure and function as those of the B light liquid crystal light valve 25a. In other words, as shown in FIG. 2 and so on, the first polarization film PF1 of the polarization filter 25g can selectively transmit only the P polarized light, the liquid crystal panel 26c can modulate the P polarized light to the S polarized light, and the polarization filter 25j can form the outgoing light LO in the S polarization state from the modulated light emitted from the liquid crystal light valve 25c.

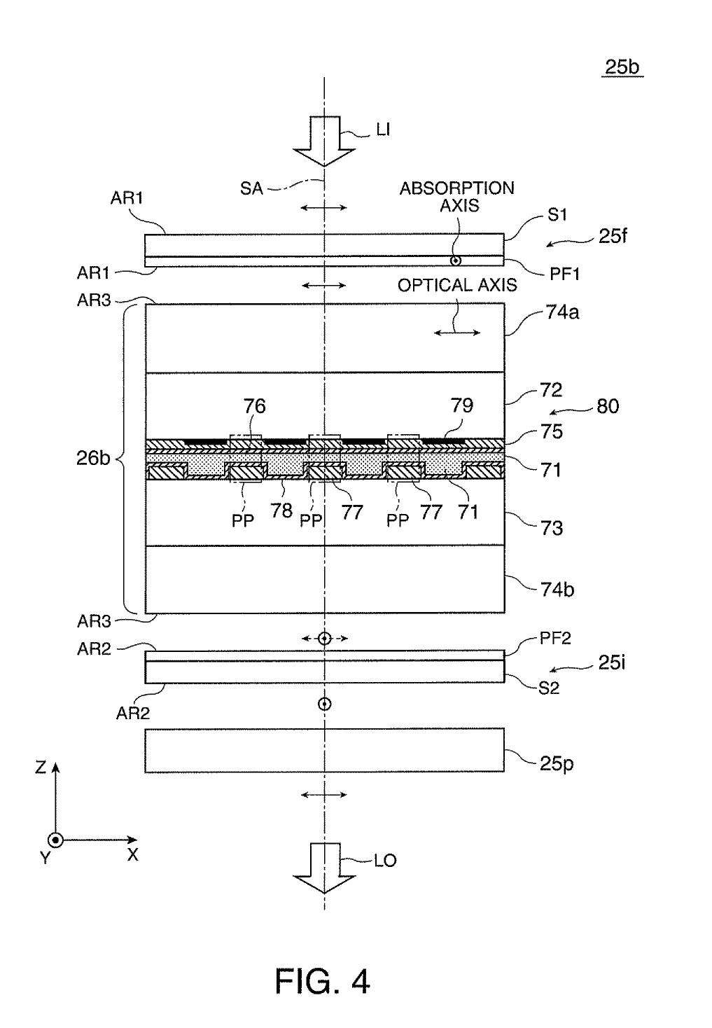

As shown in FIG. 4, the G light liquid crystal light valve 25b has basically the same structure and function as those of the B light liquid crystal light valve 25a and so on, but is different therefrom in that the 1/2 λ plate 25p is added on the light exit side. Thus, the first polarization film PF1 of the polarization filter 25f selectively transmits only the P polarized light, and the liquid crystal panel 26b modulates the P polarized light into the S polarized light. Further, the polarization filter 25i transmits only the modulated light in the S polarization state, and the 1/2 λ plate 25p can form the outgoing light LO in the P polarization state from the modulated light emitted from the liquid crystal light valve 25b.

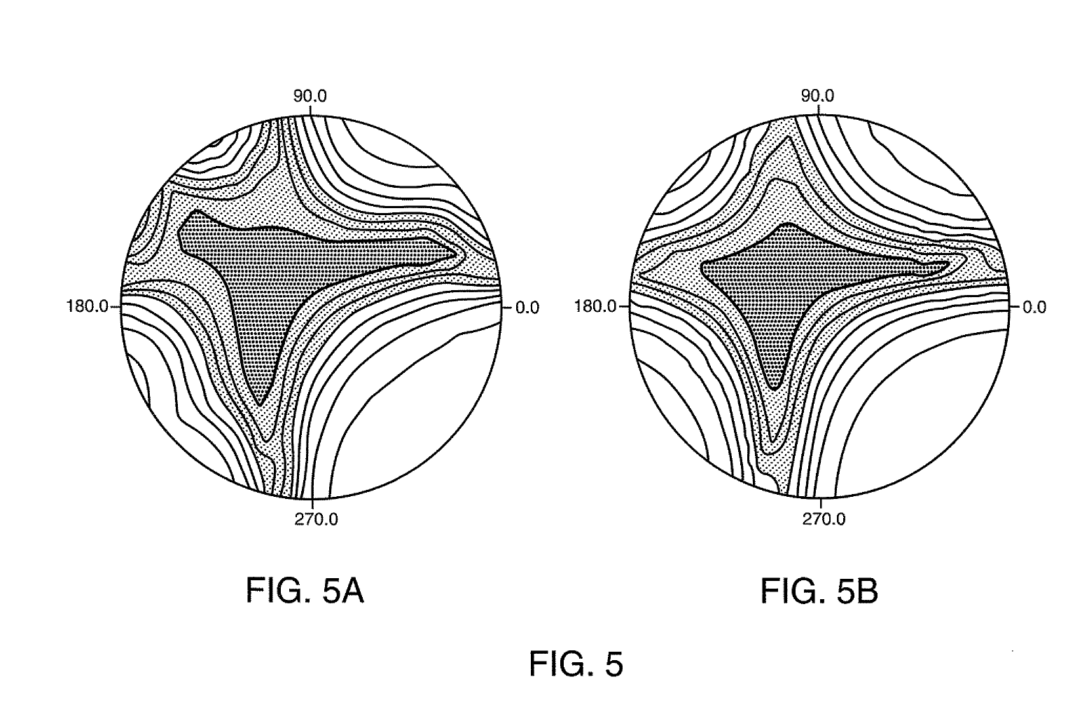

FIG. 5A is a diagram for explaining the field angle characteristic of the contrast ratio of the liquid crystal light valve 25a according to the present embodiment. It should be noted that it is arranged in this example that the thickness t of the quartz crystal plate forming the entrance-side dust-proof plate 74a is 1.1 mm. In the drawing, the direction and the distance from the center thereof indicate the direction and the angle of the field angle, and the level lines of the contrast ratio represent the field angle characteristic. As is obvious also from FIG. 5A, in the case of the liquid crystal light valve 25a according to the present embodiment, the contrast ratio becomes relatively high in a relatively broad field angle range. FIG. 5B is a diagram for explaining the field angle characteristic of the contrast ratio of a liquid crystal light valve according to a comparative example. Although the liquid crystal light valve in the comparative example has basically the same structure as that of the liquid crystal light valve 25a and so on, the optical axis of the entrance-side dust-proof plate 74a is disposed in parallel to the absorption axis of the polarization filter 25e. In other words, the optical axis of the entrance-side dust-proof plate 74a of the comparative example extends in the Y axis direction. In the case of the comparative example, the range with the high contrast ratio is somewhat narrowed.

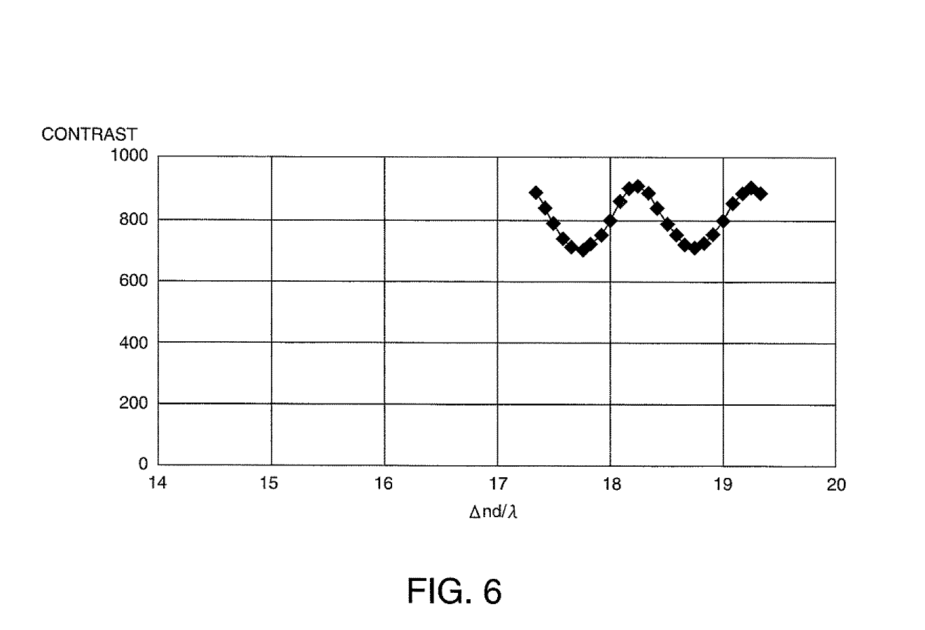

FIG. 6 is a graph for explaining the variation in the contrast ratio in the case in which the thickness of the entrance-side dust-proof plate 74a is varied in the liquid crystal light valve 25a. It should be noted that it is arranged in this example that an adjustable range of the thickness t of the quartz crystal plate forming the entrance-side dust-proof plate 74a is 1040 through 1160 μm. As is obvious also from the graph, it is understood that the contrast ratio increases or decreases along a sinusoidal variation centered on the average value of 800 in accordance with the variation of the thickness of the entrance-side dust-proof plate 74a. It is understood that the period of the variation in this case is Δnd/λ, a peak exists in a range of N through N+1/2, and the contrast ratio is relatively improved in this range. In other words, by adjusting the refractive index difference Δn and the thickness d of the entrance-side dust-proof plate 74a so as to satisfy the following relational expression, it is possible to provide the characteristic that the phase difference caused in the entrance-side dust-proof plate cancels the phase difference caused in the liquid crystal light valve 25a.

N≦Δnd/λ≦N+1/2 (1)

Thus, the field angle characteristic of the liquid crystal light valve 25a is compensated, thereby improving the contrast. Here, considering the function of the entrance-side dust-proof plate 74a, in the case in which the optical axis of the entrance-side dust-proof plate 74a is in the condition perpendicular to the absorption axis of the polarization filter 25e as in the present embodiment, it is conceivable that a composite optical element composed of the entrance-side dust-proof plate 74a and the polarization filter 25e as a group performs birefringent action on the obliquely incident component entering at a tilt with the system optical axis SA as already explained above. In other words, it can be said that the composite optical element composed of the entrance-side dust-proof plate 74a and the polarization filter 25e as a group performs an action similar to that of a uniaxial element having the optical axis in a direction parallel to the system optical axis SA. In particular, in the case in which Δnd/λ is within the range of the relational expression 1, it is conceivable that the composite optical element described above apparently performs negative uniaxial action. Here, regarding the vertically-aligned liquid crystal panel 26a and a twisted nematic liquid crystal panel described later, it has been confirmed that there is a compensation effect by a negative uniaxial optical element having an optical axis in a direction parallel to the system optical axis SA. Therefore, it is conceivable that the contrast ratio of the liquid crystal light valve 25a is slightly raised by adjusting the refractive index difference Δn and the thickness d of the entrance-side dust-proof plate 74a so that the relational expression 1 is satisfied.

Going back to FIG. 1, the cross dichroic prism 27 corresponds to a light combining optical system and has a substantially rectangular planar shape formed of four rectangular prisms bonded with each other, and on the interfaces on which the rectangular prisms are bonded with each other, there is formed a pair of dichroic mirrors 27a, 27b intersecting with each other forming an X-shape. Both the dichroic mirrors 27a, 27b are formed of respective dielectric multilayer films having characteristics different from each other. Specifically, one of the pair of dichroic mirrors, the first dichroic mirror 27a, reflects the B light while the other of the pair of dichroic mirrors, the second dichroic mirror 27b, reflects the R light. The cross dichroic prism 27 reflects the B light modulated and transmitted by the liquid crystal light valve 25a with the first dichroic mirror 27a to emit the B light rightward in the traveling direction, transmits the G light modulated and transmitted by the liquid crystal light valve 25b to emit the G light straight through the first and second dichroic mirrors 27a, 27b, and reflects the R light modulated and transmitted by the liquid crystal light valve 25c with the second dichroic mirror 27b to emit the R light leftward in the traveling direction. It should be noted that as already explained above, the first and second dichroic mirrors 27a, 27b reflect the B light and the R light in the S polarization state perpendicular to the sheet, and both the dichroic mirrors 27a, 27b transmit the G light in the P polarization state parallel to the sheet. Thus, the combination efficiency of the B light, G light, and R light in the cross dichroic prism 27 can be improved, and the color variation can be prevented from occurring.

As a projection section or a projection optical system, the projection lens 29 projects the color image light, which is formed by the combining operation of the cross dichroic prism 27, on the screen (not shown) with a desired magnification. In other words, a color moving image or a color still image corresponding to the drive signals or the image signals input to the respective liquid crystal panels 26a through 26c is projected on the screen with a desired magnification.

According to the projector 10 described above, since the direction of the absorption axes of the polarization filters 25e, 25f, and 25g on the entrance side and the direction of the optical axis of the entrance-side dust-proof plate 74a made of a positive uniaxial crystalline material are perpendicular to each other in the liquid crystal light valves 25a, 25b, and 25c of the respective colors, the entrance-side dust-proof plate 74a does not perform the birefringent action on the light beam entering in the state parallel to the system optical axis SA when the light beam is transmitted through the polarization filters 25e, 25f, and 25g. Therefore, it is possible to prevent the phenomenon that the modulated light with varied modulation amount due to the refractive index anisotropy of the entrance-side dust-proof plate 74a is emitted, while improving the cooling efficiency by the entrance-side dust-proof plate 74a. Further, it is conceivable that even if the entrance-side dust-proof plate 74a performs the birefringent action on the light beam entering in the state tilted with respect to the system optical axis SA in the liquid crystal light valves 25a, 25b, and 25c described above, the action can be canceled out with the birefringent action caused in the liquid crystal panels 26a, 26b, and 26c, respectively. Therefore, the modulated light having the field angle characteristic compensation effect of the liquid crystal panels 26a, 26b, and 26c on the light beam tilted from the system optical axis SA can be obtained, and thus the liquid crystal light valves 25a, 25b, and 25c with preferable field angle characteristics with respect to the contrast ratio can be provided.

### Second Embodiment

Hereinafter, a projector according to a second embodiment of the invention incorporating a modulation optical system will be explained. The projector according to the second embodiment is obtained by modifying the projector according to the first embodiment, and therefore, is the same as that in the first embodiment except the part particularly explained below.

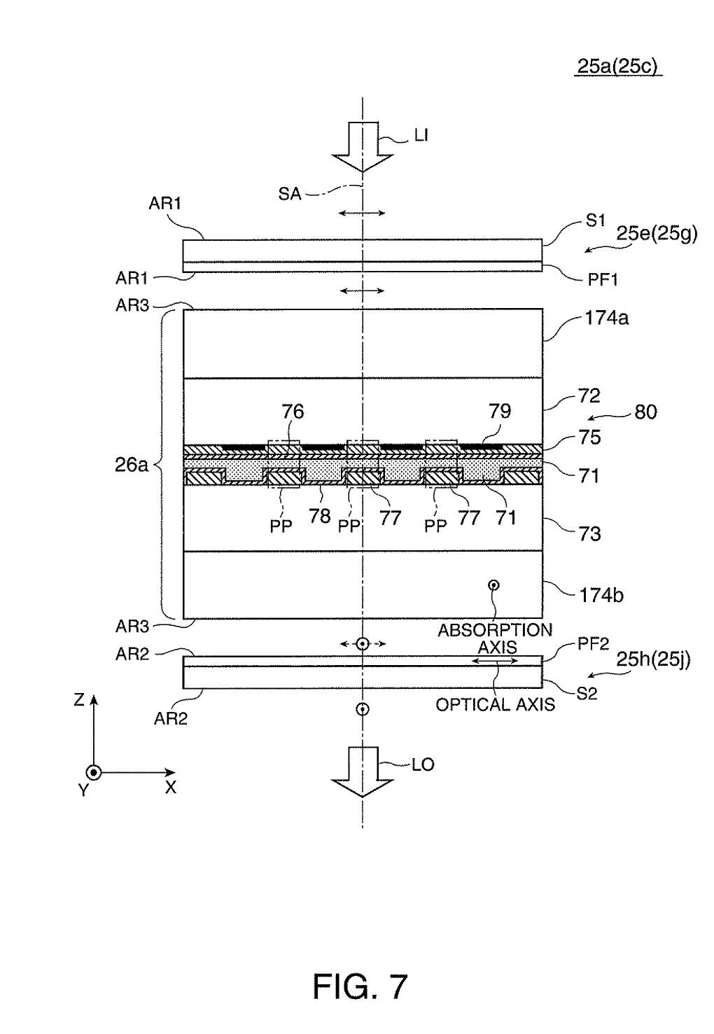

FIG. 7 is an enlarged cross-sectional view for explaining the structure of the B light liquid crystal light valve 25a incorporated in the projector according to the second embodiment. In the case with the liquid crystal light valve 25a, on the outer side of the first substrate 72, there is attached a light transmissive entrance-side dust-proof plate 174a, and on the outer side of the second substrate 73, there is attached a light transmissive exit-side dust-proof plate 174b. Each of these dust-proof plates 174a, 174b has a planar shape, and is arranged to have the entrance surface and the exit surface with normal lines parallel to the system optical axis SA, namely the Z axis, similarly to the case of the polarization filter 25e and so on. Here, the entrance-side dust-proof plate 174a is a flat plate made of an isotropic inorganic material, specifically quartz glass, and the exit-side dust-proof plate 174b is a flat plate made of a positive uniaxial crystalline material, specifically quartz crystal. The exit-side dust-proof plate 174b is hewed out so that the optical axis of the quartz crystal forming the plate extends in the Y axis direction. In other words, the optical axis of the exit-side dust-proof plate 174b is arranged to have a state perpendicular to the absorption axis of the polarization filter 25h.

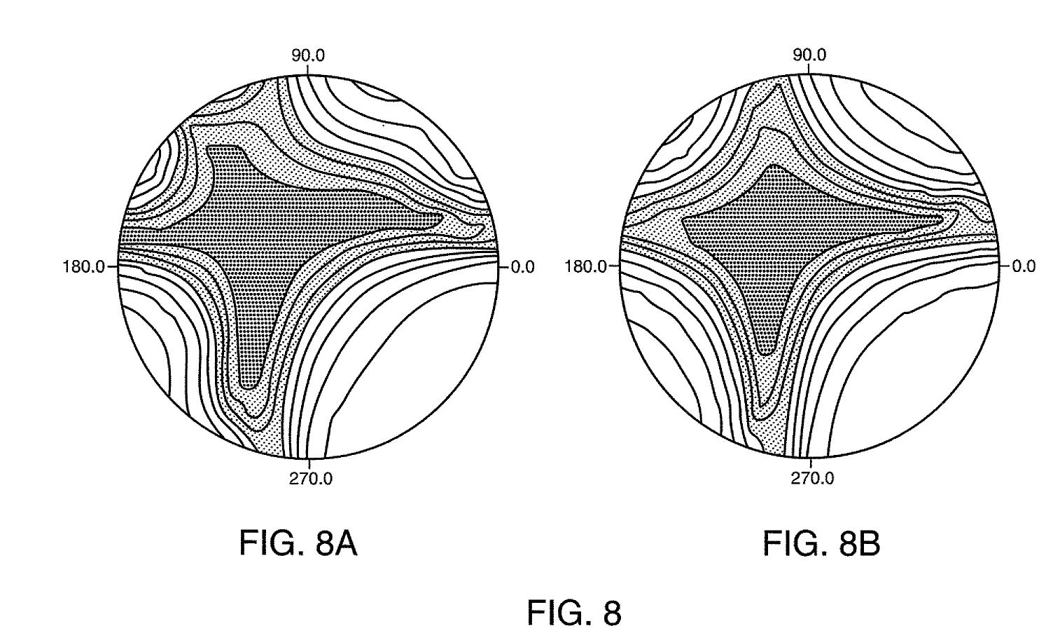

FIG. 8A is a diagram for explaining the field angle characteristic of the contrast ratio of the liquid crystal light valve 25a according to the present embodiment. It should be noted that it is arranged in this example that the thickness t of the quartz crystal plate forming the exit-side dust-proof plate 174b is 1.1 mm. As is obvious also from the drawing, in the case of the liquid crystal light valve 25a according to the present embodiment, the contrast ratio becomes relatively high in a relatively broad field angle range. FIG. 8B is a diagram for explaining the field angle characteristic of the contrast ratio of a liquid crystal light valve according to a comparative example. Although the liquid crystal light valve in the comparative example has basically the same structure as that of the liquid crystal light valve 25a and so on, the optical axis of the exit-side dust-proof plate 174b is disposed in parallel to the absorption axis of the polarization filter 25h. In other words, the optical axis of the exit-side dust-proof plate 174b of the comparative example extends in the X axis direction. In the case of the comparative example, the range with the high contrast ratio is somewhat narrowed.

It should be noted that although detailed explanations thereof will be omitted, the R light liquid crystal light valve 25c according to the present embodiment also has substantially the same structure as that of the B light liquid crystal light valve 25a. Specifically, the exit-side dust-proof plate 174b is made of the positive uniaxial crystalline material, and the optical axis thereof is disposed perpendicularly to the absorption axis of the polarization filter 25j. Further, the G light liquid crystal light valve 25b according to the present embodiment also has substantially the same structure as that of the B light liquid crystal light valve 25a. Specifically, the exit-side dust-proof plate 174b is made of the positive uniaxial crystalline material, and the optical axis thereof is disposed perpendicularly to the absorption axis of the polarization filter 25i. It should be noted that there is added the 1/2 λ plate 25p on the light exit side of the polarization filter 25i.

### Third Embodiment

Hereinafter, a projector according to a third embodiment of the invention incorporating a modulation optical system will be explained. The projector according to the third embodiment is obtained by modifying the projector according to the first embodiment, and therefore, is the same as that in the first embodiment except the part particularly explained below.

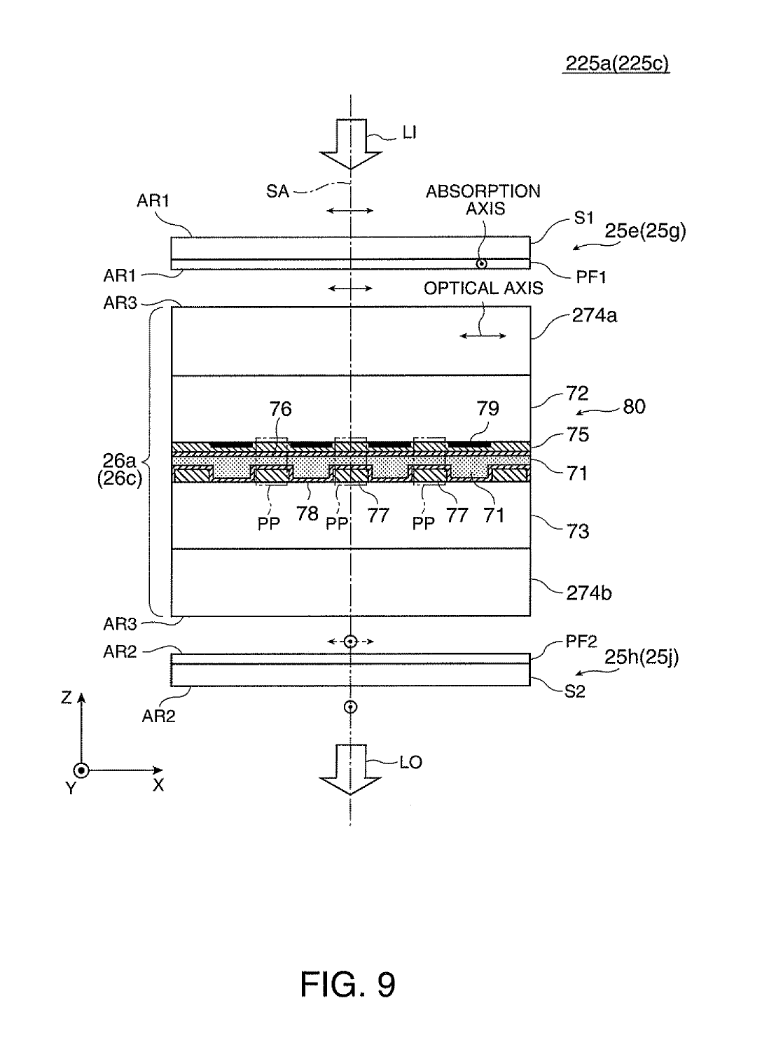

FIG. 9 is an enlarged cross-sectional view for explaining the structure of the B light liquid crystal light valve 225a incorporated in the projector according to the third embodiment. In the case of the liquid crystal light valve 225a, the entrance-side dust-proof plate 274a attached on the outer side of the first substrate 72 is formed of sapphire as a negative uniaxial crystalline material, and is hewed out so that the optical axis of the sapphire extends in the X axis direction. In other words, the optical axis of the entrance-side dust-proof plate 274a is arranged to have a state perpendicular to the absorption axis of the polarization filter 25e. Meanwhile, the exit-side dust-proof plate 274b is a flat plate made of an isotropic inorganic material, specifically quartz glass. The entrance-side dust-proof plate 274a and the exit-side dust-proof plate 274b are disposed so that the normal lines of the entrance surface and the exit surface become parallel to the system optical axis, namely the Z axis.

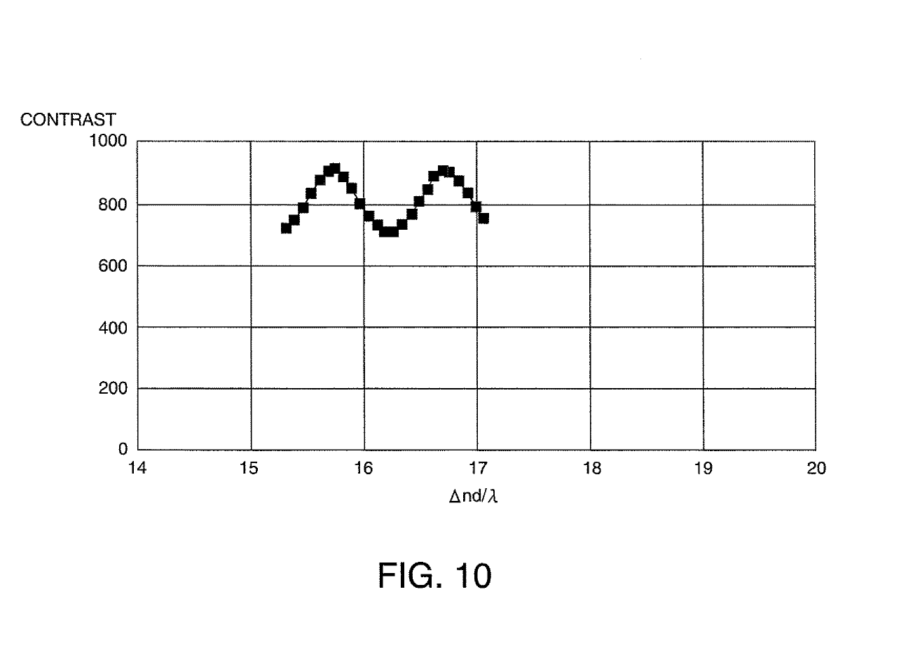

FIG. 10 is a graph for explaining the variation in the contrast ratio in the case in which the thickness of the entrance-side dust-proof plate 274a is varied in the liquid crystal light valve 225a. It should be noted that it is arranged in this example that an adjustable range of the thickness t of the quartz crystal plate forming the entrance-side dust-proof plate 274a is 1040 through 1160 μm. As is obvious also from the graph, it is understood that the contrast ratio increases or decreases along a sinusoidal variation centered on the average value of 800 in accordance with the variation of the thickness of the entrance-side dust-proof plate 274a. It is understood that the period of the variation in this case is Δnd/λ, a peak exists in a range of N−1/2 through N, and the contrast ratio is relatively improved in this range. In other words, by adjusting the refractive index difference Δn and the thickness d of the entrance-side dust-proof plate 274a so as to satisfy the following relational expression, it is possible to provide the characteristic that the phase difference caused in the entrance-side dust-proof plate cancels the phase difference caused in the liquid crystal light valve 25a.

N−1/2≦Δnd/λ≦N (2)

Thus, the field angle characteristic of the liquid crystal light valve 25a is compensated, thereby improving the contrast. Here, considering the function of the entrance-side dust-proof plate 274a, in the case in which the optical axis of the entrance-side dust-proof plate 274a is in the condition perpendicular to the absorption axis of the polarization filter 25e as in the present embodiment, it can be said that a composite optical element composed of the entrance-side dust-proof plate 274a and the polarization filter 25e as a group performs the action similar to that of the uniaxial element having an optical axis in a direction parallel to the system optical axis SA. In particular, in the case in which Δnd/λ is within the range of the relational expression 2, it is conceivable that the composite optical element described above apparently performs negative uniaxial action. Here, regarding the vertically-aligned liquid crystal panel 26a, it has been confirmed that there is a compensation effect by a negative uniaxial optical element having an optical axis in a direction parallel to the system optical axis SA. Therefore, it is conceivable that the contrast ratio of the liquid crystal light valve 25a is slightly raised by adjusting the refractive index difference Δn and the thickness d of the entrance-side dust-proof plate 274a so that the relational expression 2 is satisfied.

In the case in which the entrance-side dust-proof plate 274a is made of a negative uniaxial crystalline material, although the reason that the variation is shifted a half period compared to the case of the entrance-side dust-proof plate 74a made of a positive uniaxial crystalline material shown in FIG. 6 is not clear, but is thought to be due to the fact that the thickness necessary for providing the birefringent property having the characteristic of compensating the field angle of the liquid crystal light valve 225a is different owing to the relationship between the absorption direction, and the low refractive index direction and the high refractive index direction of the entrance-side dust-proof plate 274a.

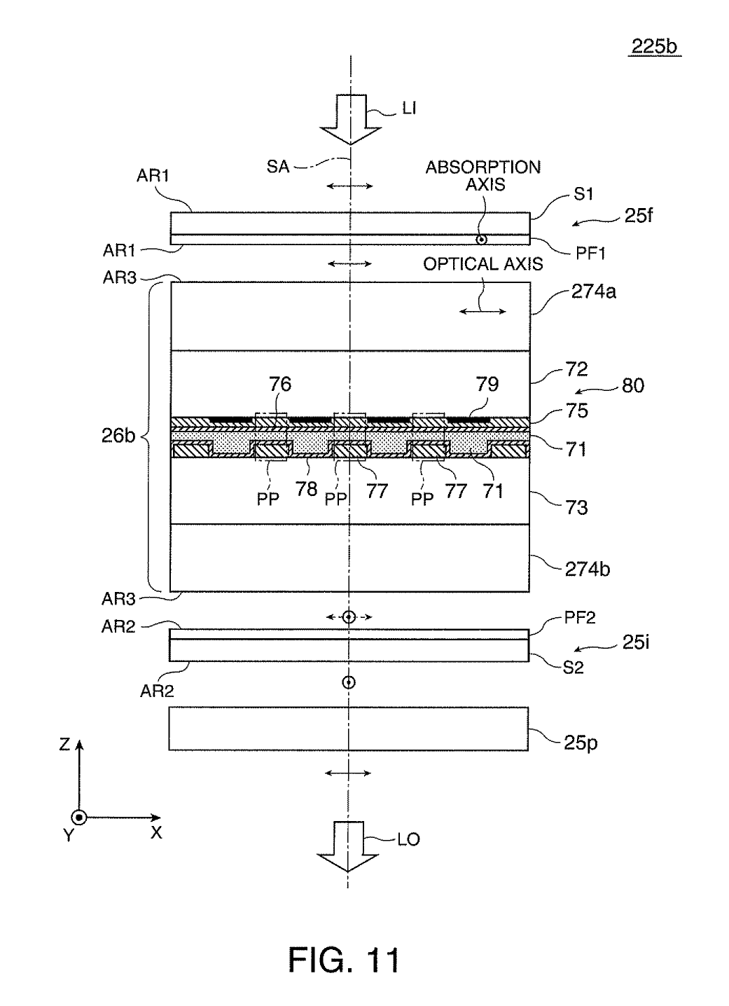

It should be noted that the R light liquid crystal light valve 225c according to the present embodiment also has substantially the same structure as that of the B light liquid crystal light valve 225a. Specifically, the entrance-side dust-proof plate 274a is made of the negative uniaxial crystalline material, and the optical axis thereof is disposed perpendicularly to the absorption axis of the polarization filter 25g (see FIG. 9). Further, the G light liquid crystal light valve 225b according to the present embodiment also has substantially the same structure as that of the B light liquid crystal light valve 225a. Specifically, the entrance-side dust-proof plate 274a is made of the negative uniaxial crystalline material, and the optical axis thereof is disposed perpendicularly to the absorption axis of the polarization filter 25f. It should be noted that there is added the 1/2 λ plate 25p on the light exit side of the polarization filter 25i (see FIG. 11).

### Fourth Embodiment

Hereinafter, a projector according to a fourth embodiment of the invention incorporating a modulation optical system will be explained. The projector according to the fourth embodiment is obtained by modifying the projector according to the third embodiment, and therefore, is the same as that in the third embodiment except the part particularly explained below.

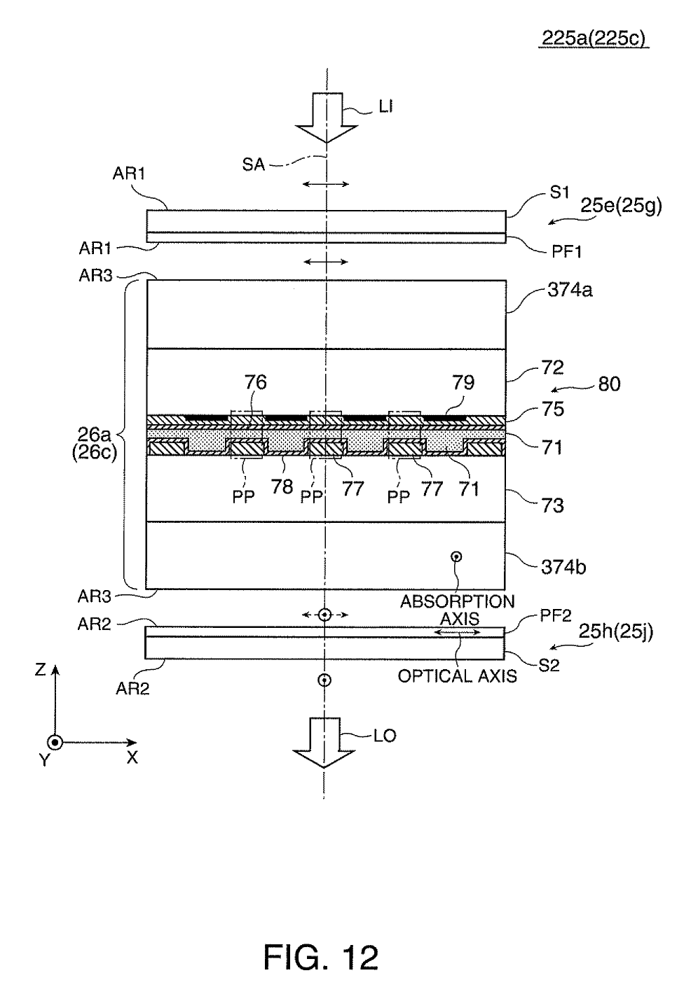

FIG. 12 is an enlarged cross-sectional view for explaining the structure of the B light liquid crystal light valve 225a incorporated in the projector according to the fourth embodiment. In the case with the liquid crystal light valve 225a, on the outer side of the first substrate 72, there is attached a light transmissive entrance-side dust-proof plate 374a, and on the outer side of the second substrate 73, there is attached a light transmissive exit-side dust-proof plate 374b. Each of these dust-proof plates 374a, 374b has a planar shape, and is arranged to have the entrance surface and the exit surface with normal lines parallel to the system optical axis SA, namely the Z axis, similarly to the case of the polarization filter 25e and so on. Here, the entrance-side dust-proof plate 374a is a flat plate made of an isotropic inorganic material, specifically quartz glass, and the exit-side dust-proof plate 374b is a flat plate made of a negative uniaxial crystalline material, specifically sapphire. The exit-side dust-proof plate 374b is hewed out so that the optical axis of the sapphire forming the plate extends in the Y axis direction. In other words, the optical axis of the exit-side dust-proof plate 374b is arranged to have a state perpendicular to the absorption axis of the polarization filter 25h.

It should be noted that although detailed explanations thereof will be omitted, the R light liquid crystal light valve 225c according to the present embodiment also has substantially the same structure as that of the B light liquid crystal light valve 225a. Specifically, the exit-side dust-proof plate 374b is made of the negative uniaxial crystalline material, and the optical axis thereof is disposed perpendicularly to the absorption axis of the polarization filter 25j. Further, the G light liquid crystal light valve 225b according to the present embodiment also has substantially the same structure as that of the B light liquid crystal light valve 225a. Specifically, the exit-side dust-proof plate 374b is made of the negative uniaxial crystalline material, and the optical axis thereof is disposed perpendicularly to the absorption axis of the polarization filter 25i. It should be noted that there is added the 1/2 λ plate 25p on the light exit side of the polarization filter 25i.

### Fifth Embodiment

Hereinafter, a projector according to a fifth embodiment incorporating a modulation optical system will be explained. The projector according to the fifth embodiment is obtained by modifying the projector according to any one of the first through fourth embodiments, and therefore, is the same as that in the first embodiment except the part particularly explained below.

The liquid crystal light valves 25a, 25b, 25c, 225a, 225b, and 225c incorporated in the projector according to the fifth embodiment are each provided with a liquid crystal layer 71 formed of the liquid crystal (i.e., twisted nematic liquid crystal) operating in the twisted nematic mode. In this case, the optical axis of the liquid crystalline compound in the liquid crystal layer 71 is disposed so as to gradually be twisted from the first substrate 72 to the second substrate 73. In other words, the optical axes of a pair of liquid crystalline compound respectively disposed on the both ends of the liquid crystal layer 71 adjacent to the inner sides of the first and second substrates 72, 73, namely the oriented films 76, 78 form a twist angle of, for example, 90° with each other when projected on the XY plane. Thus, the liquid crystal layer 71 held between the pair of polarization films PF1, PF2 is operated in a normally white mode, and it becomes possible to assure the maximum transmission state (lighting state) in an off state in which no voltage is applied. Specifically, the liquid crystal panel 26a switches the S polarized light to the P polarized light for transmission when performing white display in the lighting mode, and transmits the P polarized light directly without any modification when performing black display in the extinction state.

It should be noted that in the case, for example, of modifying the projector 10 according to the first embodiment, there is no change in the point that the direction of the absorption axes of the polarization filters 25e, 25f, and 25g and the direction of the optical axis of the entrance-side dust-proof plate 74a as the positive uniaxial crystalline material are perpendicular to each other. Further, in the case of modifying the projector 10 according to the second embodiment, there is no change in the point that the direction of the absorption axes of the polarization filters 25h, 25i, and 25j and the direction of the optical axis of the exit-side dust-proof plate 174b as the positive uniaxial crystalline material are perpendicular to each other. Likewise, in the case of modifying the projector 10 according to the third embodiment, there is no change in the point that the direction of the absorption axes of the polarization filters 25e, 25f, and 25g and the direction of the optical axis of the entrance-side dust-proof plate 274a as the negative uniaxial crystalline material are perpendicular to each other. Further, in the case of modifying the projector 10 according to the fourth embodiment, there is no change in the point that the direction of the absorption axes of the polarization filters 25h, 25i, and 25j and the direction of the optical axis of the exit-side dust-proof plate 374b as the negative uniaxial crystalline material are perpendicular to each other.

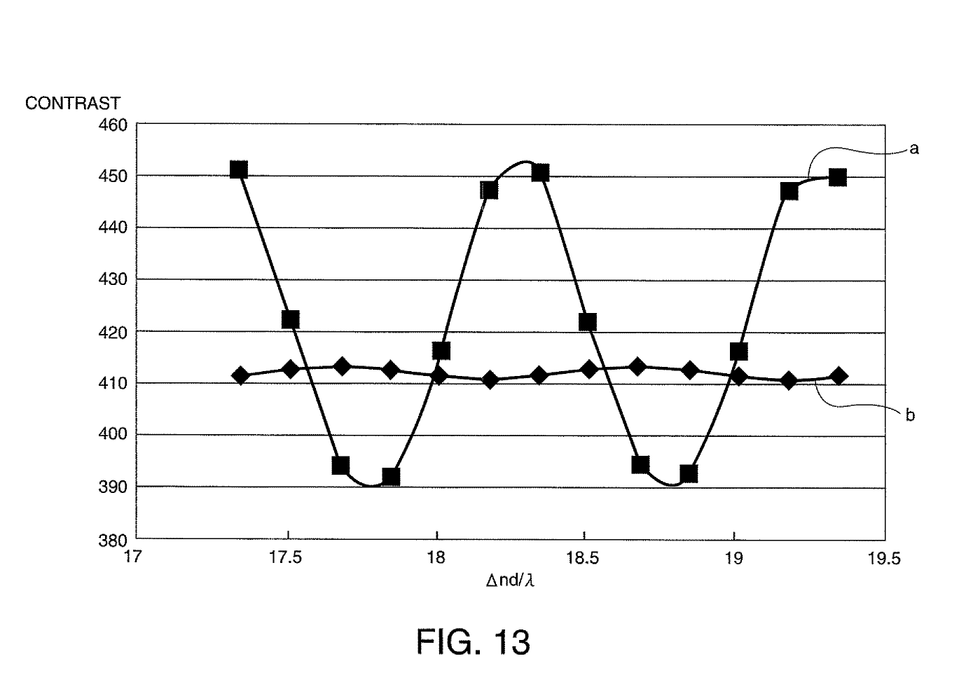

FIG. 13 is a graph for explaining the variation in the contrast ratio in the case in which the thickness of the entrance-side dust-proof plate 74a is varied in the liquid crystal light valve 25a obtained by modifying the first embodiment to have the twisted nematic type. Here, the curve a represents the variation in the contrast ratio in the case in which the direction of the absorption axis of the polarization filter 25e and the direction of the optical axis of the entrance-side dust-proof plate 74a are perpendicular to each other. In contrast, the curve b represents the variation in the contrast ratio in the case in which the direction of the absorption axis of the polarization filter 25e and the direction of the optical axis of the entrance-side dust-proof plate 74a are parallel to each other.

As is obvious also from the graph, it is understood that the contrast ratio increases or decreases along a sinusoidal variation in accordance with the variation of the thickness of the entrance-side dust-proof plate 74a. It is understood that the period of the variation in this case is And, a peak exists in a range of N through N+1/2, and the contrast ratio is relatively enhanced in this range. In other words, even in the case of the liquid crystal panel 26a provided with the twisted nematic liquid crystal layer 71, by adjusting the refractive index difference Δn and the thickness d of the entrance-side dust-proof plate 74a so as to satisfy the following relational expression, it is possible to provide the characteristic that the phase difference caused in the entrance-side dust-proof plate cancels the phase difference caused in the liquid crystal light valve 25a, 225a.

N≦Δnd/λ≦N+1/2 (1)

Thus, the field angle characteristic of the liquid crystal light valves 25a, 225a is compensated, thereby improving the contrast. Here, considering the function of the entrance-side dust-proof plates 74a, 274a, in the case in which the optical axis of the entrance-side dust-proof plates 74a, 274a is in the condition perpendicular to the absorption axis of the polarization filter 25e as in the present embodiment, it can be said that a composite optical element composed of the entrance-side dust-proof plates 74a, 274a and the polarization filter 25e as a group performs the action similar to that of the uniaxial element having an optical axis in a direction parallel to the system optical axis SA. In particular, in the case in which Δnd/λ is within the range of the relational expression 1, it is conceivable that the composite optical element described above apparently performs negative uniaxial action. As described above, regarding the twisted nematic liquid crystal panel 26a, it has been confirmed that there is a compensation effect by a negative uniaxial optical element having an optical axis in a direction parallel to the system optical axis SA. Therefore, it is conceivable that the contrast ratio of the liquid crystal light valves 25a, 225a is slightly raised by adjusting the refractive index difference Δn and the thickness d of the entrance-side dust-proof plate 74a so that the relational expression 1 is satisfied.

Hereinabove, although the invention is explained along the embodiments, the invention is not limited to the embodiments described above, but can be put into practice in various forms within the scope or the spirit of the invention, and the following modifications, for example, are also possible.

Specifically, although in the first and the third embodiments it is arranged that the entrance-side dust-proof plate 74a is made of a positive or negative uniaxial crystal, and in the second and the fourth embodiments it is arranged that the exit-side dust-proof plate 74b is made of a positive or negative uniaxial crystal, it is also possible to make both of the entrance-side dust-proof plate and the exit-side dust-proof plate of the positive or negative uniaxial crystal.

Further, although in the first through fifth embodiments described above an optical compensation plate is not incorporated, it is also possible to insert an optical compensation plate made of a crystalline material and capable of providing a phase difference between, for example, the polarization filters 25e, 25f, 25g and the liquid crystal panels 26a, 26b, 26c, in the liquid crystal light valves 25a, 25b, 25c, respectively.

Further, although in the projector 10 of the embodiments described above, the light source device 21 is composed of the light source lamp 21a, the pair of lens arrays 21d, 21e, the polarization conversion member 21g, and the overlapping lens 21i, the lens arrays 21d, 21e and so on can be eliminated, and the light source lamp 21a can be replaced with another light source such as an LED.

Although in the embodiments described above, only the example of the projector 10 using three liquid crystal light valves 25a through 25c is cited, the invention can be applied to a projector using two liquid crystal light valves or a projector using four or more liquid crystal light valves.

Although in the embodiments described above, only an example of the front projector for performing projection from the direction in which the screen is observed is cited, the invention can be applied to rear projectors for performing projection from the direction opposite to the direction in which the screen is observed.

The entire disclosure of Japanese Patent Application No. 2008-332977, filed Dec. 26, 2008 is expressly incorporated by reference herein.

What is claimed is:

1. A liquid crystal display device comprising:
a liquid crystal panel having a liquid crystal device and a dust-proof plate disposed on at least one of a light entrance side and a light exit side of the liquid crystal device; and
a first polarization filter disposed so as to be opposed to the liquid crystal panel across the dust-proof plate,
a direction of an absorption axis of the first polarization filter and a direction of an optical axis of the dust-proof plate being perpendicular to each other, and
the dust-proof plate being made of a positive uniaxial crystalline material, and satisfying a following relational expression denoting a refractive index difference with respect to two directions perpendicular to a system optical axis as Δn, a thickness in a system optical axis direction as d, and a wavelength to be used as λ, and using an integer N:
N≦Δnd/λ≦N+1/2.

2. The liquid crystal display device according to claim 1, wherein
the dust-proof plate is made of quartz crystal.

3. A liquid crystal display device, comprising:
a liquid crystal panel having a liquid crystal device and a dust-proof plate disposed on at least one of a light entrance side and a light exit side of the liquid crystal device; and
a first polarization filter disposed so as to be opposed to the liquid crystal panel across the dust-proof plate,
a direction of an absorption axis of the first polarization filter and a direction of an optical axis of the dust-proof plate being perpendicular to each other, and
the dust-proof plate being made of a negative uniaxial crystalline material, and satisfying a following relational expression denoting a refractive index difference with respect to two directions perpendicular to a system optical axis as Δn, a thickness in a system optical axis direction as d, and a wavelength to be used as λ, and using an integer N:
N−1/2≦Δnd/λ≦N.

4. The liquid crystal display device according to claim 3, wherein
the dust-proof plate is made of sapphire.

5. The liquid crystal display device according to claim 1, wherein
the liquid crystal device has a pair of substrates adapted to hold a liquid crystal layer on both sides of the liquid crystal layer, and a displaying electrode formed on one of the pair of substrates.

6. The liquid crystal display device according to claim 3, wherein
the liquid crystal device has a pair of substrates adapted to hold a liquid crystal layer on both sides of the liquid crystal layer, and a displaying electrode formed on one of the pair of substrates.

7. The liquid crystal display device according to claim 1, further comprising:
a second polarization filter disposed across the liquid crystal panel from the first polarization filter.

8. The liquid crystal display device according to claim 3, further comprising:
a second polarization filter disposed across the liquid crystal panel from the first polarization filter.

9. A projector comprising:
an illumination device adapted to emit a light beam for illumination;
a color separation optical system adapted to separate a plurality of colored light beams from the light beam emitted from the illumination device, and lead the plurality of colored light beams to optical paths of respective colors corresponding to the colored light beams;
a light modulation section having the liquid crystal display device according to claim 1 disposed on each of the optical paths of the respective colors, and adapted to modulate corresponding one of the plurality of colored light beams in accordance with image information;
a light combining optical system adapted to combine the modulated light beams of the respective colors from the liquid crystal display devices of the respective colors disposed on the optical paths of the respective colors, and emit the combined light beam; and
a projection optical system adapted to project the combined light beam formed by combining the modulated light beams through the light combining optical system.

10. A projector comprising:
an illumination device adapted to emit a light beam for illumination;
a color separation optical system adapted to separate a plurality of colored light beams from the light beam emitted from the illumination device, and lead the plurality of colored light beams to optical paths of respective colors corresponding to the colored light beams;
a light modulation section having the liquid crystal display device according to claim 3 disposed on each of the optical paths of the respective colors, and adapted to modulate corresponding one of the plurality of colored light beams in accordance with image information;
a light combining optical system adapted to combine the modulated light beams of the respective colors from the liquid crystal display devices of the respective colors disposed on the optical paths of the respective colors, and emit the combined light beam; and
a projection optical system adapted to project the combined light beam formed by combining the modulated light beams through the light combining optical system.

11. The projector according to claim 9, wherein
the illumination device emits the illumination light beam with a polarization direction aligned in a predetermined direction,
the liquid crystal display devices of the respective colors modulate the colored light beams with a common polarization direction,
the light combining optical system has at least one dichroic mirror tilted around an axis passing through a system optical axis and perpendicular to the system optical axis, and combines image light beams of the respective colors using a wavelength characteristic of the at least one dichroic mirror, and
the light modulation section has a first type liquid crystal display device adapted to emit a modulated light beam to be reflected by the at least one dichroic mirror, and a second type liquid crystal display device adapted to emit a modulated light beam to be transmitted through the at least one dichroic mirror as the liquid crystal display devices of the respective colors, and has a phase plate adapted to switch the polarization direction 90° disposed between either one of the first type liquid crystal display device and the second type liquid crystal display device, and the light combining optical system.

12. The projector according to claim 10, wherein
the illumination device emits the illumination light beam with a polarization direction aligned in a predetermined direction,
the liquid crystal display devices of the respective colors modulate the colored light beams with a common polarization direction,
the light combining optical system has at least one dichroic mirror tilted around an axis passing through a system optical axis and perpendicular to the system optical axis, and combines image light beams of the respective colors using a wavelength characteristic of the at least one dichroic mirror, and
the light modulation section has a first type liquid crystal display device adapted to emit a modulated light beam to be reflected by the at least one dichroic mirror, and a second type liquid crystal display device adapted to emit a modulated light beam to be transmitted through the at least one dichroic mirror as the liquid crystal display devices of the respective colors, and has a phase plate adapted to switch the polarization direction 90° disposed between either one of the first type liquid crystal display device and the second type liquid crystal display device, and the light combining optical system.
